(19) United States
(12) Patent Application Publication
(10) Pub. No.: US 2025/0182113 A1
(43) Pub. Date: Jun. 5, 2025

(54) SYSTEMS AND METHODS FOR VERIFICATION SERVICES

(71) Applicant: Wells Fargo Bank, N.A., San Francisco, CA (US)

(72) Inventors: Frank Fehrenbach, New York, NY (US); Greg J. Hansen, Palo Alto, CA (US); Mattie L. Morris, Chandler, AZ (US); Ashish B. Kurani, Hillsborough, CA (US)

(73) Assignee: Wells Fargo Bank, N.A., San Francisco, CA (US)

(21) Appl. No.: 18/525,667

(22) Filed: Nov. 30, 2023

(51) Int. Cl. G06Q 20/40; G06Q 20/10; G06Q 20/32; G06Q 20/42; G06Q 40/02

(52) U.S. Cl. CPC G06Q 20/4014; G06Q 20/108; G06Q 20/4016; G06Q 20/42; G06Q 40/02; G06Q 20/3223

(57) ABSTRACT

A system includes at least one processing circuit having at least one processor coupled to at least one memory device. The at least one processing circuit performs operations including: storing data regarding a plurality of transaction parties; receiving, from a user device, data regarding a transaction request for a transaction between a first party and a second party, the data including a first set of party characteristics associated with the first party; verifying the first set of party characteristics based on determining that the first party is one of the plurality of transaction parties; determining that at least one characteristic of the first set of party characteristics is incorrect based on comparing the first set of party characteristics with the data regarding the plurality of transaction parties; and causing the user device to display a notification indicating that the at least one characteristic is incorrect.

### FIELD

The present disclosure relates to systems, computer-readable media, and methods for verification services.

### BACKGROUND

A payer may use an online platform to wire funds to a payee. Payer information, such as an account number (e.g., a bank account number) and other information, may be used to identify a payer account from which funds are removed for the transaction. Payee information, such as an account number and other information, may be used to identify a payee account to which funds are transferred. For example, a payer may use a payee-provided account number when performing a transaction. The payer may also designate a payor account from which funds are removed for the transaction. As electronic transactions have grown in popularity, so have the number of fraudsters that attempt to mislead parties to a transaction and/or infiltrate computer systems for the transaction. Yet, the number of electronic transactions that occur on a daily basis are immense, such that the computer resources required to fraud-check each transaction are great. Improved verification and fraud tools are desired.

### SUMMARY

One embodiment relates to a system that includes at least one processing circuit having at least one processor coupled to at least one memory device. The at least one memory device stores instructions therein that, when executed by the at least one processor, cause the at least one processing circuit to perform various operations. The operations include storing data regarding a plurality of transaction parties; receiving, from a user device, data regarding a transaction request for a transaction between a first party and a second party, the data regarding the transaction request comprising a first set of party characteristics associated with the first party; verifying the first set of party characteristics based on determining that the first party is one of the plurality of transaction parties; determining that at least one characteristic of the first set of party characteristics is incorrect based on comparing the first set of party characteristics with the data regarding the plurality of transaction parties; and causing the user device to display a notification indicating that the at least one characteristic is incorrect. In some embodiments, the notification is overlayed on a transaction portal interface.

Another embodiment relates to a method. The method incudes storing, by a provider computing system, data regarding a plurality of transaction parties; receiving, by the provider computing system and from a user device, data regarding a transaction request for a transaction between a first party and a second party, the data regarding the transaction request including a first set of party characteristics associated with the first party; verifying, by the provider computing system, the first set of party characteristics based on determining that the first party is one of the plurality of transaction parties; determining, by the provider computing system, that at least one characteristic of the first set of party characteristics is incorrect based on comparing the first set of party characteristics with the data regarding the plurality of transaction parties; and causing, by the provider computing system, the user device to display a notification indicating that the at least one characteristic is incorrect. In some embodiments, the notification is overlayed on a transaction portal interface.

Another embodiment relates to a non-transitory computer-readable storage media having instructions stored thereon that, when executed by at least one processor of a computing system, cause the computing system to perform operations. The operations include storing data regarding a plurality of transaction parties; receiving, from a user device, data regarding a transaction request for a transaction between a first party and a second party, the data regarding the transaction request comprising a first set of party characteristics associated with the first party; verifying the first set of party characteristics based on determining that the first party is one of the plurality of transaction parties; determining that at least one characteristic of the first set of party characteristics based on comparing the first set of party characteristics with the data regarding the plurality of transaction parties; and causing the user device to display a notification indicating that the at least one characteristic is incorrect. In some embodiments, the notification is overlayed on a transaction portal interface.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 illustrates a block diagram of a computing system for enabling and implementing a verification service, according to an example embodiment.

FIG. 2 illustrates a flow diagram of a method of verifying a request using a verification service, according to an example embodiment.

FIG. 3 illustrates another flow diagram of a method of verifying a request using a verification service, according to an example embodiment.

FIG. 4 illustrates still another flow diagram of a method of verifying a request using a verification service, according to an example embodiment.

FIG. 5 is a graphical user interface (GUI) illustrating a transaction request, according to an example embodiment.

FIG. 6 is a GUI illustrating a verification of the transaction request of FIG. 5, according to an example embodiment.

### DETAILED DESCRIPTION

Referring generally to the Figures, systems, computer-readable media, and methods for enabling a verification service, such as for a transaction or a potential transaction, using improved graphical user interfaces are disclosed, according to various embodiments herein. As described herein, the systems, computer-readable media, and methods operate in real-time or near real-time to verify a transaction request before the transaction is executed. For example, and in executing online transactions, a risk point for a payer sending a resource (e.g., money) to a payee is a fraudster pretending to be the payee and giving the payer an account number associated with the fraudster and not the intended payee. Then, when the payer pays the fraudulent account number, the wired funds are typically not recoverable. Thus, improved transaction verification tools are desired to mitigate errant and/or fraudulent transactions from being executed.

As described herein, a provider institution, such as a financial institution (FI), may maintain a database regarding transactions (e.g., payments) processed by the provider institution and information included in transactions requests (e.g., account numbers, names of payers and payees, such as names of companies and/or individuals, address information for the parties to a transaction, etc.). Over time, new transactions and corresponding information may be stored in the database thereby increasing the data pool associated with transactions. As described herein, this database may be used at least in part to provide a verification service by the provider institution for transactions.

In an example operating scenario, a provider institution, such as a financial institution, may provide a verification service for verifying transactions before executing the transactions. In some arrangements, the verification service includes an interactive user interface that may be provided on or with a transaction portal. In some arrangements, the transaction portal is a third-party transaction portal (e.g., a transaction portal not provided by the provider institution). In other arrangements, the provider institution also provides the transaction portal (e.g., via one or more applications). The user interface enables a transaction verification operation. For example, when a user (e.g., a payer or a payee, also referred to herein as a “party”) interacts with the user interface, a provider computing system associated with the provider institution may automatically or nearly automatically verify the transaction information (e.g., data input by a payer or payee regarding the transaction) by comparing the transaction information with historical transaction information stored by the database. As used herein, a “party” may be an entity that is a participant of a transaction. For example, a “party” may be an individual, a company such as a financial institution or other business, and so on. Furthermore, the “party” may be a payee or a payer. Thus, it should be understood that a “payee” and a “payer” are both types of parties. As described herein, the verification service may be used in a variety of scenarios including, but not limited to, a first scenario with “existing” parties where each party of a transaction has previously performed transaction with one another, a second scenario where at least one party (e.g., a payer or a payee) is a “new” party that has not previously performed transaction with another party of the transaction, a third scenario for ad-hoc or one-time payments between parties, and a fourth scenario where each party of a transaction has previously performed transaction with one another, but one or more changes to at least one party's information has changed (e.g., change in name, change in address, change in account number, etc.). Each of the example scenarios is described herein.

In any of the above-described scenarios, a database of a provider institution computing system may store data regarding one or more parties. The data may include an account number, an address, a company name regarding each of the one or more parties (e.g., company name if a company, etc.), and other information regarding the one or more parties. The data may also include a historical record of transactions involving each of the one or more parties, such as a number of transactions performed, a period of time during which transactions were performed, a number of transactions per time period (e.g., transactions per month, transactions per year, transactions in the last 12 months, year to date transactions, etc.), and/or other metrics related to transactions involving each of the one or more parties (e.g., a historical record of transactions between a first party and a second party, etc.).

Based on the foregoing, a first example scenario relates to using the verification service with existing parties, where each party of a transaction has previously performed transaction with one another. For example, the first scenario may include a first party that has previously been involved in transaction with a second party. The provider institution computing system may use the data stored in the database to enable an improved verification service using the stored information regarding the first party and/or the second party. The provider institution computing system may use the data to verify a transaction performed via a transaction portal before the transaction is executed. For example, a payee (e.g., the first party) may input data regarding the transaction (e.g., a recipient's name, account number, amount, memo, and so on) via a graphical user interface (GUI) of the transaction portal. Before executing the transaction, the provider institution computing system may receive transaction information via the transaction portal GUI and analyze the information as part of the verification process/service. In some arrangements, the analysis includes determining whether the payer (e.g., the first party) has performed a predefined amount (e.g., number, quantity, etc.) transactions with the payee (e.g., the second party). In this way, the provider institution computing system may determine if the payee is a repeat payee. Responsive to determining that the payee is a repeat payee based on (i) a number of transactions between the payer and the payee and/or (ii) a number of transactions between the payee and another party exceeding a predefined threshold value, the provider computing system may determine whether an error or potential error is present in the transaction information (e.g., incorrect recipient name, account number, amount, and so on) based on comparing the transaction information with data regarding at least one previous transaction between the payer and the payee and/or data regarding transactions involving the payee and another party. In some arrangements, the analysis includes identifying the payee based on previous transactions between the payee and other payers. For example, the provider computing system may identify data regarding previous transactions involving a payee with the same recipient name, the same account number, and/or other suitable information. The provider computing system may determine whether an error or potential error is present in the transaction information based on comparing the data regarding the previous transactions with the transaction information.

A second example scenario relates to using the verification service with a “new” party that has not previously performed transaction with another party of the transaction. For example, the second scenario may include a first party that has not previously been involved in transaction with a second party. The provider institution computing system may use the data stored in the database to enable an improved verification service using the stored information regarding the second party. The provider institution computing system may use the data to verify a transaction performed via a transaction portal before the transaction is executed. For example, the first party may input data regarding the transaction (e.g., a recipient's name, account number, amount, memo, and so on) via a graphical user interface (GUI) of the transaction portal. Before executing the transaction, the provider institution computing system may receive transaction information, via the transaction portal GUI and analyze the information as part of the verification process. In some arrangements, the analysis includes determining whether the second party has performed a predefined amount (e.g., number, quantity, etc.) transactions with another party (e.g., another payer or another payee). In this way, the provider institution computing system may determine if the second party is a repeat party (e.g., a repeat payer or repeat payee). Responsive to determining that the second party is a repeat party based on a number of transactions between the second party and another party (e.g., a party other than the first party) exceeding a predefined threshold value, the provider computing system may determine whether an error or potential error is present in the transaction information (e.g., incorrect payer name, payee name, account number, amount, and so on) based on comparing the transaction information with data regarding at least one previous transaction between the second party and another party. In some arrangements, the analysis includes identifying the second party based on previous transactions between the second party and other parties. For example, the provider computing system may identify data regarding previous transactions involving a party with the same name, the same account number, and/or other suitable information. The provider computing system may determine whether an error or potential error is present in the transaction information based on comparing the data regarding the previous transaction(s) with the transaction information.

A third example scenario relates to using the verification service for ad-hoc or one-time payments between parties that have not previously performed transaction with one another. For example, the third scenario may include a first party that has not previously been involved in transaction with a second party. The transaction verification process may be substantially similar to or the same as the verification process described in the second example scenario.

A fourth example scenario relates to using the verification service for transactions where each party of a transaction has previously performed transaction with one another, but one or more changes to at least one party's information has changed (e.g., change in name, change in address, change in account number, etc.). For example, the fourth scenario may include a first party that has previously been involved in transaction with a second party. The provider institution computing system may use the data stored in the database to enable an improved verification service using the stored information regarding the first party and/or the second party. The provider institution computing system may use the data to verify a transaction performed via a transaction portal before the transaction is executed. For example, the first party may input data regarding the transaction (e.g., a recipient's name, account number, amount, memo, and so on) via a graphical user interface (GUI) of the transaction portal. Before executing the transaction, the provider institution computing system may receive transaction information via the transaction portal GUI and analyze the information as part of the verification process. In some arrangements, the analysis includes determining whether the first party has performed a predefined amount (e.g., number, quantity, etc.) transactions with the second party. In this way, the provider institution computing system may determine if the payee is a repeat payee. Responsive to determining that the payee is a repeat payee based on (i) a number of transactions between the first party and the second party and/or (ii) a number of transactions between the second party and another party exceeding a predefined threshold value, the provider computing system may determine whether a change in the second party's information is present based on comparing the transaction information with data regarding at least one previous transaction between the payer and the payee and/or data regarding transactions involving the payee and another party. In some arrangements, the analysis includes verifying a legitimacy of the change in the second party's information. For example, the provider computing system may identify data regarding recent transactions (e.g., transactions executed within a predetermined time period) involving the second party with the same recipient name, the same account number, and/or other suitable information, but a change in at least a portion of the second party's information. The provider computing system may determine whether the change in the second party's information is legitimate based on determining that the change is present in both the data regarding the previous transactions and the transaction information.

In some arrangements, the provider computing system may determine a confidence value using one or more formulas, algorithms, processes, and/or models (e.g., statistical models) that is indicative of whether the data input by the payer (e.g., payee information, recipient name, account number, and so on) is correct. The confidence value may be a numeric value, whereby higher confidence values indicate higher likelihoods that no error is present in the payer input data. Thus, the confidence value may be expressed as a percentage (e.g., 0%-100%), an absolute numeric value, and/or some other value (e.g., a 0-to-10 scale, a 0-to-100 scale, etc.) The value may be converted to another symbol in some embodiments, such as on a color scale whereby red hues indicate low confidence and green hues indicate relatively higher confidences (as an example). Based on the foregoing and in some arrangements, responsive to determining that at least one characteristic of the payee input data is incorrect or likely incorrect such that the confidence value is below a predetermined confidence value threshold, the provider computing system may send a notification to the payer indicating that the at least one characteristic is incorrect or is likely incorrect.

In some arrangements, the provider computing system is also configured to flag (e.g., set an identifier regarding) potentially fraudulent inbound payment requests and/or inbound payments. For example, if a payer receives an invoice from a spoofed (e.g., fraudulent) vendor, the provider institution computing system is configured to flag the invoice as potentially fraudulent based on comparing information from the invoice with information in the database. Flagging potentially fraudulent inbound payment requests may include creating a digital mark or other identifier that indicates that the inbound payment request is potentially fraudulent. The data regarding the potentially fraudulent inbound payment request, including one or more flags, may be stored in the database. In some embodiments, the flags may be transmitted to a user device.

Technically and beneficially, the systems, computer-readable media, and methods described herein may reduce an amount of transmissions needed to execute a transaction by verifying a transaction request before the transaction request is submitted and processed. For example, in a conventional transaction processing system, errant or fraudulent transaction requests may be executed without a user's (e.g., a requester) knowledge that the transaction request had errors or was potentially fraudulent. Recovering funds from errant or fraudulent transactions may be difficult and require numerous transmissions and human actions. Advantageously, the systems, computer-readable media, and methods described herein verify a transaction request before the transaction request is executed, thereby reducing the amount of network communication transmissions associated with potentially fraudulent transaction because errant or fraudulent transaction requests are prevented from being executed. In particular, the systems, computer-readable media, and methods described herein may advantageously eliminate transmissions related to identifying fraudulent transactions after a transaction is executed and/or transmissions related to recovering funds from errant or fraudulent transactions. Furthermore, the systems, computer-readable media, and methods described herein including a non-conventional step of performing a verification step before executing a transaction, compared to conventional steps of executing transactions. The extra verification step may delay processing, ultimately, but advantageously provides a fraud-check that is atypical to conventional execution of transactions.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

### Example System

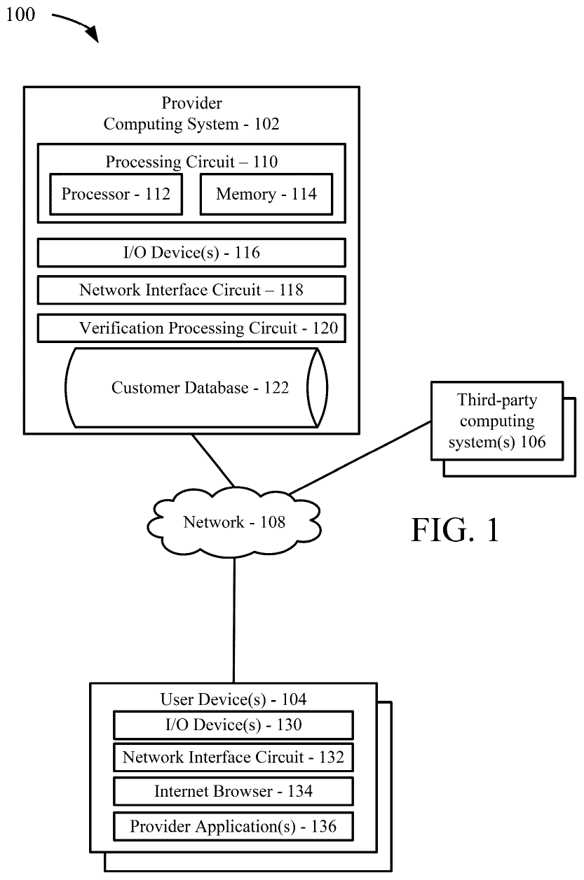

Referring now to FIG. 1, a diagram of a computing system 100 for enabling and providing a verification service, such as a transaction verification service, is shown, according to an example embodiment. The computing system 100 includes a provider computing system 102 and one or more user devices 104. In some embodiments, the computing system 100 includes one or more third-party computing systems 106. The provider computing system 102, the one or more user devices 104, and the one or more third-party computing systems 106 are in communication with each other and are connected by a network 108. The network 108 permits the direct or indirect exchange of data, values, instructions, messages, and the like (represented by the lines in FIG. 1). In some arrangements, the network 108 is configured to communicatively couple to additional computing system(s). For example, the network 108 may facilitate communication of data between the provider computing system 102 and other computing systems associated with the provider or with a customer of the provider such as a user device (e.g., a mobile device, smartphone, desktop computer, laptop computer, tablet, or any other computing system). The network 108 may include one or more of a cellular network, the Internet, Wi-Fi, Wi-Max, a proprietary provider network, a proprietary retail or service provider network, and/or any other kind of wireless or wired network.

The provider computing system 102 is owned by, associated with, or otherwise operated by a provider. The provider entity or institution may provide one or more products and/or services. In the example shown, the provider institution is a financial institution (FI). Accordingly, the provider institution may provide one or more financial products and/or services, such as issuing and maintaining of accounts (e.g., credit card accounts, savings accounts or other demand deposit accounts, etc.), lending services (e.g., home lending, auto lending, etc.), authentication and authorization services, and so on. Thus, the provider institution and provider computing system 102 may hold and maintain one or more accounts held by various users (e.g., a user associated with the one or more user devices 104.

In some instances, the provider computing system 102 may be or include one or more servers, each with one or more processing circuits having one or more processors configured to execute instructions stored in one or more memory devices perform at least the operations described herein. In some instances, the provider computing system 102 may be or include and/or have various other devices communicably coupled thereto, such as, for example, desktop or laptop computers (e.g., tablet computers), smartphones, wearable devices (e.g., smartwatches), and/or other suitable devices.

In some embodiments, the provider computing system 102 includes at least one processing circuit 110, one or more I/O devices 116, a network interface circuit 118, a verification processing circuit 120, and a customer database 122.

The at least one processing circuit 110 includes at least one processor 112 and at least one memory 114. The memory 114 may be one or more devices (e.g., RAM, ROM, Flash memory, hard disk storage) for storing data and/or computer code for completing and/or facilitating at least certain of the various processes described herein. The memory 114 may be or include non-transient volatile memory, non-volatile memory, and/or non-transitory computer storage media. The memory 114 may include database components, object code components, script components, or any other type of information structure for supporting the various activities and information structures described herein. The memory 114 may be communicatively coupled to the processor 112 and include computer code or instructions for executing one or more processes described herein. The processor 112 may be implemented as one or more application-specific integrated circuits (ASICs), field programmable gate arrays (FPGAs), a group of processing components, or other suitable electronic processing components. As such, the processing circuit 110 is configured to run a variety of application programs and store associated data in a database of the memory 114.

The one or more I/O devices 116 are configured to receive inputs from and provide information to a user. While the term “I/O” is used, it should be understood that the I/O devices 116 may be input-only devices, output-only devices, and/or a combination of input and output devices. As an example, the I/O devices 116 may be or include a keyboard, a keypad, a mouse, a joystick, a touch screen, a microphone, a biometric device, a virtual reality headset, smart glasses, and the like. As another example, I/O devices 116 may be or include, but are not limited to, a television monitor, a computer monitor, a printer, a facsimile, a speaker, and so on. Each of the one or more I/O devices 116 may include their own dedicated processing circuit(s) that are communicably coupled to the other components and systems of the system 100.

The network interface circuit 118 is structured to receive communications from and provide communications to the i/o device(s) 116, other computing devices, users, and the like associated with the provider computing system 102. In this regard, the network interface circuit 118 is structured to exchange data, communications, instructions, and the like with a communication device or circuit of the components of the system 100 over the network 108. In some arrangements, the network interface circuit 118 includes communication circuitry for facilitating the exchange of data, values, messages, and the like between the network interface circuit 118 and the components of the provider computing system 102. In some arrangements, the network interface circuit 118 includes machine-readable media that stores instructions that is executable by one or more processors (e.g., the processor 112 or a dedicated processor(s) of the network interface circuit 118) for facilitating the exchange of information between the network interface circuit 118 and the components of the provider computing system 102. In some arrangements, the network interface circuit 118 includes any combination of hardware components, communication circuitry, and machine-readable media.

The network interface circuit 118 may include a network interface. The network interface may be used to establish connections with other computing devices by way of the network 108. The network interface may include program logic that facilitates connection of the provider computing system 102 to the network 108. In some arrangements, the network interface may include any combination of a wireless network transceiver (e.g., a cellular modem, a Bluetooth transceiver, a Wi-Fi transceiver) and/or a wired network transceiver (e.g., an Ethernet transceiver). For example, the network interface circuit 118 may include an Ethernet device such as an Ethernet card and machine-readable media such as an Ethernet driver configured to facilitate connections with the network 108. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted.

The network interface circuit 118 may enable and facilitate secure communications between the provider computing system 102 and each of the user device(s) 104. In some arrangements, the network interface circuit 118 also facilitates communication with the third-party computing system(s) 106, such as other banks, settlement systems, and/or other suitable entities. The network interface circuit 118 further includes user interface program logic configured to generate and present web pages to users accessing the provider computing system 102 over the network 108.

In some arrangements, the network interface circuit 118 includes suitable input/output ports and/or uses an interconnect bus for interconnection with the I/O devices 116, such as a local display (e.g., a liquid crystal display, a touchscreen display) and/or keyboard/mouse devices (when applicable), or the like, serving as a local user interface for programming and/or data entry, retrieval, or other user interaction purposes. As such, the network interface circuit 118 may provide an interface for the user to interact with various applications and/or executables stored on the provider computing system 102. For example, the network interface circuit 118 may enable communication with the I/O devices 116, such as a keyboard, a keypad, a mouse, a joystick, a touch screen, a microphone, a biometric device, a virtual reality headset, smart glasses, and the like.

The verification processing circuit 120 is structured or configured to perform a variety of functionalities or operations to enable and implement a verification service, and particularly a transaction verification service, using at least some of the information stored within the customer database 122. In some arrangements, the verification processing circuit 120 performs various functionalities to enable customer registration of new customers and/or to enable customer information updates for registered customers. In some arrangements, the verification processing circuit 120 performs various functionalities to enable a variety of other services associated with and/or provided by the provider. In some arrangements, the verification processing circuit 120 may facilitate a transaction between two or more customers (or, in some embodiments, at least one non-customer of the provider institution).

The customer database 122 is structured or configured as a repository that retrievably stores information regarding a set of customers and/or non-customers (e.g., information that is associated with various parties, also referred to herein as “party data”). In some arrangements, a first set of parties may be customers of the provider institution, such that the provider institution holds or otherwise maintains an account associated with the one or more parties. In some arrangements, a second set of parties, different from the first set of parties, are not customers of the provider institution. Thus, as described herein, a transaction may be performed between a party in the first set and a party in the second set, two or more parties in the first set, and/or two or more parties in the second set.

In some instances, the party information includes information regarding a party, such as an account number (e.g., a payment account number, a demand deposit account number, or other account number), card information associated with an account of the party (e.g., credit card or debit card number), a name of an individual (if the party is an individual), a name of a company (if the party is a company), an address of the party (e.g., a mailing address, a business address, and so on), a phone number of the party, an email address of the party, and/or other information regarding the party. In some arrangements, the account number corresponds to an account associated with the party maintained by the provider computing system 102. In some arrangements, the account number corresponds to an account associated with a third-party provider and the party (third-party being relative to the provider institution and associated provider computing system 102). In these arrangements, the provider computing system 102 may retrieve at least a portion of the party information (e.g., account number, name, address, and so on) from the third-party provider (e.g., via a third-party computing system 106 over the network 108). In some instances, the party information may include information regarding previous transactions involving the party, such as a record of transactions involving the party (e.g., a number of transactions performed, a period of time during which transactions were performed, a number of transactions per time period including, but not limited to, transactions per month, transactions per year, transactions in the last 12 months, year to date transactions, etc.), and/or other metrics related to transactions involving the party. In some arrangements, the data may also include a historical record of transactions between the party and one or more of the other parties. In some instances, the party information may include historical party information, such as previous or inactive account numbers, previous addresses, previous individual names, previous company names, and so on.

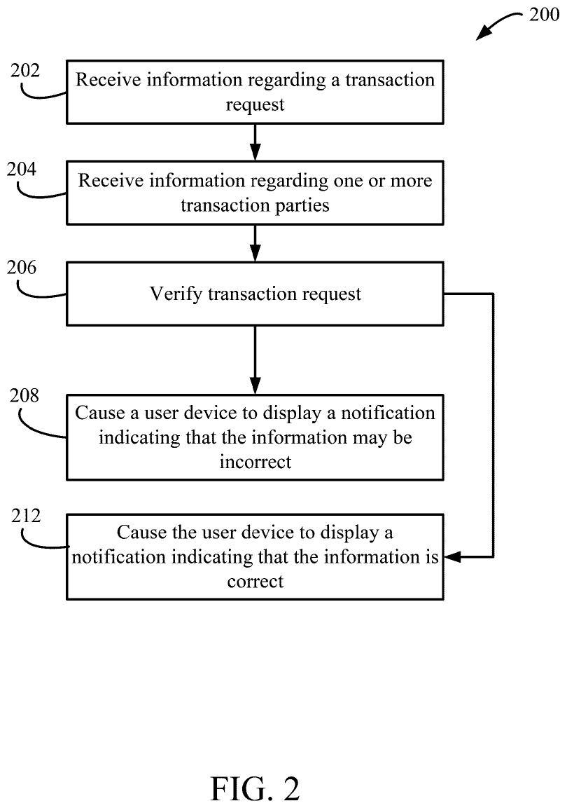

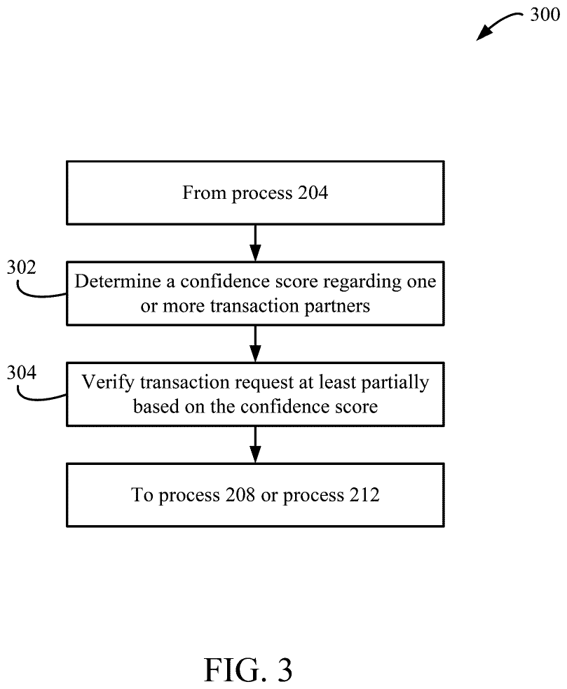

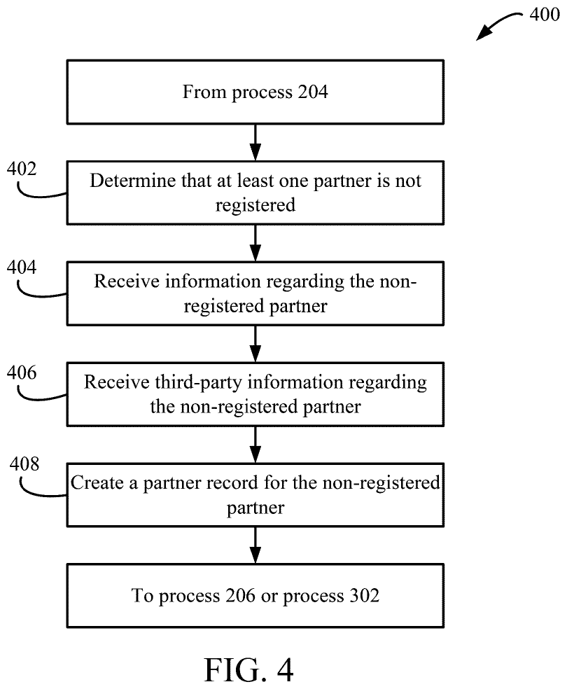

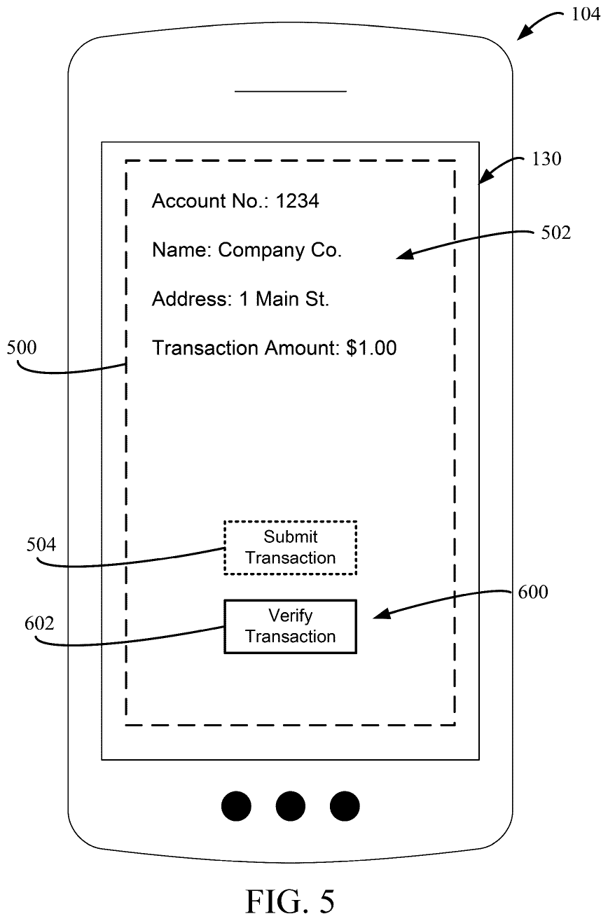

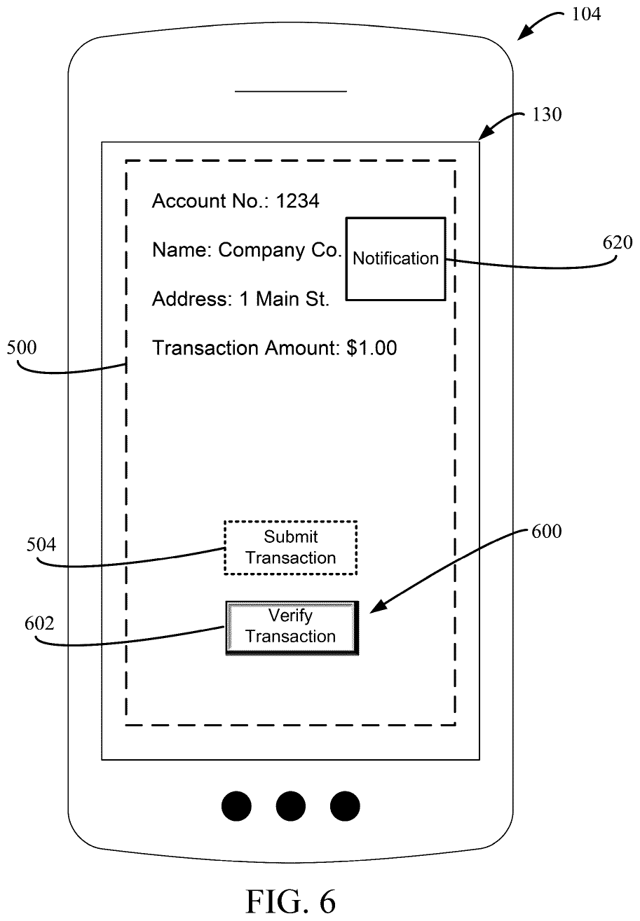

The verification processing circuit 120 is structured to enable various functionalities described herein. For example and as described in detail below, the verification processing circuit 120 is structured to enable transaction verification service, such as the verification services described below with respect to FIGS. 2 and 3. In some instances, the verification processing circuit 120 is structured to enable registration of a new party, as described in detail below, with respect to FIG. 4. In some instances, verification processing circuit 120 is structured to generate a user interface and cause a user device, such as the user device(s) 104, to display the user interface. Examples of user interfaces are shown and described herein, with respect to FIGS. 5 and 6.

The user device 104 is owned, operated, controlled, managed, and/or otherwise associated with a user. The user may or may not be a customer of the provider institution. The user may also may or may not be a customer of the third-party associated with the depicted third-party computing system. The user may be a party to a transaction. For example, the user may be a payer or a payee. In some arrangements, the payer or the payee is an individual. In other arrangements, the payer or the payee is a company. In these arrangements, the user may be an individual employed by or representing the company. Therefore, a party to a transaction may include an individual, a company, a representative of a company, an employee of a company, or other suitable entity.

The user device 104 may be or may include (i.e., there may be multiple user devices for a user) a desktop or laptop computer (e.g., a tablet computer), a smartphone, a wearable device (e.g., a smartwatch), a personal digital assistant, and/or any other suitable computing device. In the example shown, the user device 104 is structured as a smartphone. It should be understood that the parties described herein may have or operate multiple user devices. Thus, while one user device is referenced herein below, this description is not meant to be limiting. The user device 104 includes one or more I/O devices 130, a network interface circuit 132, an internet browser 134, and one or more provider applications 136. While the term “I/O” is used, it should be understood that the I/O devices 130 may be input-only devices, output-only devices, and/or a combination of input and output devices.

In some instances, the I/O devices 130 include various devices that provide perceptible outputs (such as display devices with display screens and/or light sources for visually perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, keyboard, force sensor for sensing pressure on a display screen, etc.). In some instances, the I/O devices 130 further include one or more user interfaces (devices or components that interface with the customer), which may include one or more biometric sensors (such as a fingerprint reader, a heart monitor that detects cardiovascular signals, face scanner, an iris scanner, etc.). In the example shown, the I/O devices 130 include a display device that is configured or structured to present one or more graphical user interfaces.

The network interface circuit 132 includes, for example, program logic and various devices (e.g., transceivers, etc.) that connect the user device 104 to the network 108. For example, in some instances, the program logic interfaces with one or more transceivers (e.g., Bluetooth, Wi-Fi, or any other suitable communication transceivers) to enable connection with the network 108. In some arrangements, the network interface circuit 132 includes program logic and/or devices for near filed communication capabilities and/or other suitable short-range wireless capabilities. The network interface circuit 132 facilitates secure communications between the user device 104 and each of the provider computing system 102, other user devices 104, and/or the third-party computing system(s) 106.

In some arrangements, the user device 104 stores in computer memory, and executes (“runs”) using one or more processors, an internet browser application 134. The internet browser 134 enables navigation to a website provided by a provider entity. In some arrangements, the user device 104 stores in computer memory, and executes (“runs”) using one or more processors, a provider application 136. The provider application 136 is configured to generates transaction graphical user interface (GUI), referred to herein as a “transaction portal.” In other arrangements, the transaction portal may be provided via another application and/or via websites (e.g., a website that is navigable via the internet browser application 134). In some arrangements, the transaction portal is provided by a third-party service provider (e.g., a service provider that is not associated with the provider computing system 102). In some arrangements, the transaction portal may be provided using another suitable application such as a text messaging application, and/or other applications, such as a third-party provider application. As used herein a “transaction portal” refers to a user interface of an application, a user interface of a webpage, or other suitable user or graphical user interface that enables receiving and providing information regarding a transaction. For example, a transaction portal may be or include an interface that is configured to receive data (e.g., transaction data, information regarding a party of a transaction, or other suitable data) and execute or cause execution of a transaction (e.g., a payment, a payment request, a wire transfer, and so on) based on the received data.

In some arrangements, the provider application 136 may be provided by and at least partially supported by the provider computing system 102. The provider application 136 may be coupled to the provider computing system 102 and enable a user to perform a transaction verification process. For example, the provider application 136 may provide a transaction verification application. In some instances, the provider application 136 enables various functionalities described herein (e.g., with respect to FIGS. 2-6). The provider client application 136 is a downloadable application, in some embodiments. The provider application 136 is structured to included one or more application programming interfaces (APIs) that enable the provider application 136 to communicate (e.g., exchange information) with other devices and applications (e.g., the internet browser, mobile wallet client application, third party applications, etc.). The type and number of APIs is highly configurable and customizable in order to enable communication with a high variety of devices and applications. In other embodiments, a different structural configuration may be implemented. For example, the provider application 136 may be hard coded into the user device.

In some arrangements, the user device 104 enables multiple applications to be executed concurrently or partially concurrently such that a display of the user device 104 displays an interface of a first application and a second application, concurrently or partially concurrently. As described herein with respect to FIGS. 5 and 6, the provider computing system 102 may cause the user device(s) 104 to display a transaction verification interface that is overlayed on the transaction portal. In some arrangements, the transaction verification application may be accessed without the provider application 136. For example, the transaction verification application may be accessed via an application programming interface or other suitable interface. In these embodiments, the application programming interface may enable third-party access to the transaction verification application.

The third-party computing system 106 is owned, operated, controlled, managed, and/or otherwise associated with a third-party provider (e.g., a provider that is not the provider entity associated with the provider computing system 102). The third-party provider may be a business, such as a financial institution, or other suitable entity. As briefly described above, in some arrangements, the third-party provider may provide a transaction portal that enables executing transactions. In an example arrangement, the transaction portal may be provided on the user device 104 via a third-party computing system 106 (e.g., via a third-party application). In these arrangements, the provider computing system 102 is configured to cause the user device 104 to display the transaction portal interface and the notification simultaneously.

In some arrangements, the third-party computing system 106 may be or may include, for example, a server, a desktop or laptop computer (e.g., a tablet computer), a smartphone, a wearable device (e.g., a smartwatch), a personal digital assistant, and/or any other suitable computing device.

Although not specifically shown, it will be appreciated that the third-party computing system 106 may include a network interface circuit, various databases (e.g., similar to the customer database 122), processing circuits (e.g., similar to the processing circuit 110), and/or other circuits in the same or similar manner to the other components of system 100. As such, the provider computing system 102 may communicate (e.g., send to and/or receive from) information with the third-party computing system 106. For example, the provider computing system 102 may receive party information from the third-party computing system 106.

According to an example arrangement, the provider computing system 102 may enable a transaction verification service on or at the one or more user devices 104. For example, the provider computing system 102 may provide the transaction verification service via one or more communications via the network 108, such as via an application program interface (API) call. Advantageously, the transaction verification service may mitigate fraudulent transactions by identifying and/or authenticating accurate or correct party data. Thus, the customer database 122 may be configured to store data regarding a set of parties. In some arrangements, the party data includes historical party data. In these arrangements, the provider computing system 102 may advantageously identify potentially fraudulent activity based on historical data regarding the parties (e.g., number of transactions, number of transactions within a predetermined time period, number of returned transactions, number of changes in bank account information, and/or other suitable information). In some arrangements, the provider computing system 102 determines a confidence value, such as a confidence score, regarding one or more parties of a transaction based on the party data.

Advantageously, the transaction verification service may be used in a variety of transaction scenarios including, but not limited to, a new party scenario where at least one party of a transaction has not previously been party to a transaction with the other parties, an ad hoc payment or one-time payment where at least one party of a transaction has not previously been party to a transaction with the other parties and the parties of the transactions do not anticipate future transactions with the same parties, changes to party information where a user is informed of a change in party information and wishes to verify the change in information before executing the transaction. The transaction verification service may be provided as a service to an individual and/or a business. For example, the transaction verification service may be used by an accounts payable and/or an accounts receivable team.

In an example operating scenario, the provider computing system 102 is configured to enable a transaction verification service. The customer database 122 may store data regarding a plurality of transaction parties. The provider computing system 102 may receive data regarding a transaction request for a transaction between a first party and a second party from a user device 104. The data regarding the transaction request may include a first set of party characteristics associated with the first party. The provider computing system 102 may verify the first set of party characteristics based on determining that the first party is one of the plurality of transaction parties. The provider computing system 102 may determine that at least one characteristic of the first set of party characteristics is incorrect or potentially incorrect based on comparing the first set of party characteristics with the data regarding the plurality of transaction parties. The provider computing system 102 may cause the user device 104 to display a transaction verification interface including a notification indicating that an error or potential error is present in the first set of party characteristics. The notification is overlayed on a transaction portal interface, which may be displayed by the user device 104.

In some arrangements, the customer database 122 additionally stores one or more party characteristics corresponding to each transaction party of the plurality of transaction parties. The provider computing system 102 may verify the first set of party characteristics based on determining that a second party characteristic of the first set of party characteristics matches at least one of the one or more party characteristics corresponding to the first party.

The customer database 122 may also store a number of completed transactions for each transaction party of the plurality of transaction parties. The provider computing system 102 may verify the first set of party characteristics based on determining that a number of completed transactions of the first party is at or above a predetermined threshold.

In some arrangements, the provider computing system 102 is configured to determine a confidence value (e.g., score) regarding the first party based on at least one of, comparing the first set of party characteristics to a list of party characteristics stored by the customer database, identifying a government-issued identification characteristic of the first party, a number of returned transactions initiated by the first party compared to a returned transaction threshold, and/or a type of interface of the transaction portal interface. The provider computing system 102 may verify the first set of party characteristics based on determining that the confidence value is greater than a confidence value threshold.

In some arrangements, the customer database 122 stores information regarding a number of completed transactions for each transaction party of the plurality of transaction parties. The provider computing system 102 may verify the first set of party characteristics based on determining that a number of completed transactions of the first party is at or below a predetermined threshold and that the confidence value is greater than the confidence value threshold. In some arrangements, the provider computing system 102 is configured to cause the user device 104 to display the confidence value (e.g., via a transaction verification interface). The confidence value may be overlayed on the transaction portal interface.

In some arrangements, the data regarding the transaction request may include information regarding a relationship between the parties of the transaction. For example, the data regarding the transaction request may indicate that the transaction request is for a first transaction between the first party and the second party. In another example, the data regarding the transaction request may indicate that first party and the second party have previously been parties to the same transaction.

With an example structure of the system 100 being described above, example processes performable by the system 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

### Example Methods/Processes

Referring now to FIG. 2, a flow diagram of a method 200 of verifying a transaction request is shown, according to an example embodiment. In some instances, the method 200 is performed or otherwise executed using various components of the computing system 100.

At process 202, the provider computing system 102 receives information regarding a transaction request. As described above, the transaction request may be executed via a transaction portal. The provider computing system 102 receives information regarding a transaction request from user as part of the transaction request. As described herein, the transaction portal may be provided via the provider application 136, a website that is navigable via the internet browser 134, and/or a third-party provider application. In some arrangements, when the transaction portal is provided via the provider application 136, the provider computing system 102 may receive the information included in the transaction request directly via the transaction portal (e.g., via a user input and/or via an auto-fill input executed by the user device 104 or the internet browser 134). In some arrangements, when the transaction portal is provided via the internet browser 134 and/or the third-party provider application, the provider computing system 102 may receive the information included in the transaction request via the user device 104. Thus, the user device 104 may access the transaction portal (e.g., via the network 108 and/or one or more third-party computing systems 106). The user device 104 may receive one or more user inputs regarding the transaction and/or auto-fill inputs regarding the transaction into the transaction portal. The user device 104 may provide the information included in the transaction request to the provider computing system 102 (e.g., via the network 108). Thus, in any of the above-described arrangements, the provider computing system 102 receives the information included in the transaction request.

At process 204, the provider computing system 102 retrieves information regarding one or more transaction parties. In some arrangements, the information regarding one or more transaction parties includes “stored party data.” As used herein, “stored party data” refers to previously received party data that is stored (e.g., by the customer database 122 and/or by one or more third-party computing systems 106). The stored party data may be verified (e.g., manually by a user or by one or more automated verification processes). For example, the stored party data may be verified based on one or more confidence metrics described herein with respect to FIG. 3.

In some arrangements, the provider computing system 102 retrieves information regarding one or more transaction parties from the customer database 122. In some arrangements, the provider computing system 102 receives the information regarding one or more transaction parties from one or more third-party computing systems 106.

As described above, the party data (e.g., input party data and/or stored party data) may include, but is not limited to information regarding each party of a set of parties, as part of a transaction. The party day may include, but is not limited to, an account number, card information, a name of an individual, a name of a company, an address, a phone number, an email address, and/or other suitable information regarding the party. In some instances, the party information may include information regarding previous transactions involving the party (referred to herein as historical party data or historical party information), such as a record of transactions involving the party (e.g., a number of transactions performed, a period of time during which transactions were performed, a number of transactions per time period including, but not limited to, transactions per month, transactions per year, transactions in the last 12 months, year to date transactions, etc.), transaction amounts, transaction dates, transaction frequency, and/or other metrics related to transactions involving the party. In some arrangements, the data may also include a historical record of transactions between the party and one or more of the other parties, such as a number of transactions between a first party and a second party or a number of transactions between a first party and a set of other party. In some instances, the party information may include historical party information, such as previous or inactive account numbers, previous addresses, previous individual names, previous company names, and so on.

At process 206, the provider computing system 102 verifies the transaction request. In some arrangements, the provider computing system 102 verifies the transaction request by comparing the information included in the transaction request (e.g., the input party data) with the retrieved information regarding the one or more transaction parties (e.g., the stored party data). For example, the provider computing system 102 may determine whether the input party data matches the stored party data. More specifically, the provider computing system 102 may determine that the information included in the transaction request is incorrect or is likely incorrect based on the input party data not matching the stored party data. Similarly, the provider computing system 102 may determine that the information included in the transaction request is correct or is likely correct based on the input party data matching the stored party data. Other examples of verifying the transaction request are described in greater detail herein with respect to FIG. 3.

Responsive to determining that the input party data does not match the stored party data, the method 200 continues to process 208. Responsive to determining that the input party data matches the stored party data, the method 200 continues to process 212.

At process 208, the provider computing system 102 causes a user device 104 to display a transaction verification interface including a notification indicating that the information included in the transaction request is incorrect or is likely incorrect. At process 212, the provider computing system 102 causes a user device to display a transaction verification interface including notification indicating that the information is correct or is likely correct.

FIG. 3 illustrates flow diagram of a method 300 of verifying a transaction request, according to another example embodiment. In some instances, the method 300 is performed or otherwise executed using various components of the computing system 100. The method 300 may be performed concurrently, partially concurrently, or sequentially with the method 200. In some arrangements, the method 300 is performed after process 204 of the method 200.

At process 302, the provider computing system 102 determines a confidence value (e.g., a confidence score) regarding one or more parties of a transaction request. In some arrangements, the confidence score is a value regarding a statistical probability that the received information included in the transaction request corresponds to the retrieved information regarding the one or more transaction parties (e.g., the stored party data). Thus, the confidence score may be expressed as a percentage (e.g., 0%-100%).

In some arrangements, the provider computing system 102 may determine a confidence score based on comparing the information included in the transaction request (e.g., the data input by the payer) with the information regarding one or more transaction parties (e.g., data stored in the customer database 122). In some arrangements, the provider computing system 102 may compare a first set of party characteristics of the information included in the transaction request to a list of party characteristics stored of the information regarding one or more transaction parties. In these arrangements, the confidence score may be based on or equal to a statistical probability that the received information included in the transaction request is the same as the received information regarding the one or more transaction parties. In some embodiments, the provider computing system 102 may determine the confidences score based on a difference between the input party data and the one or more predicted characteristics. The difference may be a percent difference or an absolute difference for numerical characteristics, such as transaction amounts, transaction dates, etc. The difference may include a binary indication of whether an alpha-numeric characteristic, such as name, address, account number, or other identifier of the input party data matches the stored party data. The difference may include a binary indication of potential typos for alpha-numeric characteristics, such as an indication that a potential typo occurred because alpha-numeric values are close in proximity on a keyboard. In any of the above-described embodiments, a relatively lower difference may correspond to a relatively higher confidence score, and a relatively higher difference may correspond to a relatively lower confidence score.

In some embodiments, the confidence score is a binary score. For example, if the received party data does not match the stored party data, then confidence score is 0, and if the received party data matches the stored party data, then the confidence score is 1.

In some arrangements, the provider computing system 102 may use one or more models (e.g., statistical models, machine learning models, etc.) to determine a confidence score that the received information included in the transaction request is correct. The one or more models may correlate the received information included in the transaction request and the received information regarding the one or more transaction parties with a confidence score.

In another example arrangement, the confidence score is determined responsive to receiving a government-issued identification characteristic of the one or more parties, such as a government-issued identification card (ID card). In these arrangements, the confidence score may be based on or equal to a statistical probability that the received information included in the transaction request is the same as the received government-issued identification characteristic.

In another example arrangement, the confidence score is based on a number of returned transactions initiated by each of the one or more parties compared to a returned transaction threshold. For example, if the number of returned transactions exceeds the threshold, the provider computing system 102 may determine that the confidence score is at or below a predefined value. In some arrangements, the confidence score is adjusted based on the number of returned transactions. For example, the provider computing system 102 may use a lookup table that correlates the number of returned transactions with a confidence score adjustment. The provider computing system 102 may modify a confidence score based on the confidence score adjustment.

In some arrangements, the confidence score is adjusted based on a type of interface of the transaction portal interface. For example, the provider computing system 102 may use a lookup table that correlates the type of interface of the transaction portal interface with a confidence score adjustment. The provider computing system 102 may modify a confidence score based on the confidence score adjustment.

At process 304, the provider computing system may verify the transaction request based on at least the confidence score. For example, the provider computing system 102 may determine that the first set of party characteristics is correct or is likely correct based on determining that the confidence score is greater than a confidence score threshold. The provider computing system 102 may determine that the first set of party characteristics is incorrect or is likely incorrect based on determining that the confidence score is at or below the confidence score threshold.

In some arrangements, the provider computing system 102 may determine that the first set of party characteristics is correct or likely correct based on determining that a number of completed transactions of the one or more parties is at or below a predetermined threshold and that the confidence score is greater than the confidence score threshold. In some arrangements, the provider computing system 102 may determine that the first set of party characteristics is incorrect or likely incorrect based on determining that a number of completed transactions of the one or more parties is above a predetermined threshold and/or that the confidence score is at or below the confidence score threshold.

In some arrangements, the provider computing system 102 is configured to cause the user device 104 to display the confidence score. The confidence score may be overlayed on the transaction portal interface.

The method 300 may continue to process 208 of the method 200 responsive to determining that the information included in the transaction request is incorrect or is likely incorrect. The method 300 may continue to process 212 of the method 200 responsive to determining that the information included in the transaction request is correct or is likely correct.

Referring to FIG. 2, in some embodiments, at process 208, a user may interact with the notification (e.g., via the user device 104) to view more details regarding why the information included in regarding the transaction request is incorrect or is likely incorrect. For example, responsive to receiving a user input, the provider computing system 102 may cause the user device 104 to display an additional notification that indicates how the provider computing system 102 determined that the information included in regarding the transaction request is incorrect or is likely incorrect. The additional notification may include an indication of a portion of the input party data that does not match the stored party data. The additional notification may include a confidence score.

In some embodiments, a user may interact with the notification to override the transaction verification process. In these embodiments, the provider computing system 102 may receive a user input, such as a credential, a token, or other suitable input via the user device 104. In some embodiments, responsive to receiving the user input, the provider computing system 102 may update the stored party data to include the input party data that did not match the previously stored party data. In some embodiments, responsive to receiving the user input, the provider computing system 102 may cause the user device 104 to display a notification indicating that executing the transaction request may result in an errant or fraudulent transaction.

Still referring to FIG. 2, in some embodiments, the provider computing system 102 the information regarding a transaction request received at process 202 may be from an incoming or inbound transaction request. In these embodiments, at process 206, the provider computing system 102 is configured to flag (e.g., set an identifier regarding) a potentially fraudulent inbound payment requests and/or inbound payments responsive to determining that the received party information is incorrect or is likely incorrect. For example, if a party receives an invoice from a spoofed (e.g., fraudulent) vendor, the provider computing system 102 may flag the invoice as potentially fraudulent based on comparing information from the invoice (e.g., the received party information) with stored party information. Flagging potentially fraudulent inbound payment requests may include creating a digital mark or other identifier that indicates that the inbound payment request is potentially fraudulent. The data regarding the potentially fraudulent inbound payment request, including one or more flags, may be stored in the database. In some embodiments, the flag may be transmitted to the user device 104.

Still referring to FIG. 2, in some embodiments, the provider computing system 102 may use one or more machine learning models to predict one or more characteristics of a transaction request. For example, the provider computing system 102 may use one or more machine learning models to predict a transaction amount, a transaction date, a transaction frequency, or other characteristics related to the transaction request. In some embodiments, the one or more machine learning models may be trained using historical transaction data between at least one party of the transaction request and another party, which may or may not be a party of the transaction request. The one or more predicted characteristics may be retrieved at process 204 and used to compare to the received party data at process 206. For example, the provider computing system 102 may determine that the information included in the transaction request is incorrect or is likely incorrect based on the input party data not matching the one or more predicted characteristics. Similarly, the provider computing system 102 may determine that the information included in the transaction request is correct or is likely correct based on the input party data matching the one or more predicted characteristics. In some embodiments, the one or more predicted characteristics may be retrieved at process 204 and used to determine the confidences score at process 302. For example, the provider computing system 102 may determine the confidences score based on a difference (e.g., a percent difference, an absolute difference, etc.) between the input party data and the one or more predicted characteristics. For example, a relatively lower difference may correspond to a relatively higher confidence score, and a relatively higher difference may correspond to a relatively lower confidence score.

FIG. 4 illustrates flow diagram of a method 400 of verifying a transaction request, according to yet another example embodiment. The method 400 may be performed concurrently, partially concurrently, or sequentially with the method 200 and/or the method 300. In some arrangements, the method 400 is performed after process 204 of the method 200.

At process 402, the provider computing system 102 determines that at least one party of the transaction request is not “registered.” As used herein, a “registered” party refers to a party having corresponding data stored by the customer database 122. For example, the customer database 122 stores data regarding a registered party. Thus, a non-registered party is a party that does not have corresponding data stored by the customer database 122.

In some arrangements, the provider computing system 102 may determine that a party is not registered based on the received information regarding a transaction request not matching or being different from data stored by the customer database 122. In some arrangements, the provider computing system 102 may determine that a party is not registered based on the received information regarding a transaction request not matching or being different from the received information regarding one or more transaction parties (e.g., the stored party data).

At process 404, the provider computing system 102 receives information regarding the non-registered party. In some arrangements, the information regarding the non-registered party may include the input party data received at process 202. For example, the input party data may include an account number, an account name, a company name, an individual's name, one or more preferences of the non-registered party, such as a preferred payment account, a preferred currency, and so on.

At process 406, the provider computing system 102 receives third-party information regarding the non-registered party. In some arrangements, the third-party information regarding the non-registered party may include data received from one or more third-party computing systems 106. In some arrangements, the third-party information regarding the non-registered party includes information received from the non-registered party. In any of the above-described arrangements, the third-party information regarding the non-registered party includes an account number, an address, a company name, an individual's name, a historical record of transactions involving the first party, such as a number of transactions performed, a period of time during which transactions were performed, a number of transactions per time period (e.g., transactions per month, transactions per year, transactions in the last 12 months, year to date transactions, etc.), other metrics related to transactions involving the non-registered party, and/or other information regarding the non-registered party.

At process 408, the provider computing system 102 creates a party record for the non-registered party. When the provider computing system 102 creates the record, the non-registered party becomes registered. The method 400 may continue to process 206 or to process 302.

### Example User Interfaces

FIG. 5 depicts an example user interface 500 for display on a user device 104. More specifically, the user interface 500 may be displayed on an I/O device 130 of the user device 104, such as a display screen, a touch screen, or other suitable display device.

The user interface 500 is a transaction portal interface. As described above, the transaction portal interface may be provided by the provider computing system 102 and/or the third-party computing system(s) 106 (e.g., via the network 108).

The user interface 500 may facilitate submitting a transaction request. The user interface 500 may include one or more input fields 502 that are structured to receive user inputs for the transaction request. More specifically, the one or more input fields 502 may receive input party data. The user interface 500 also includes one or more interactive icons 504 for submitting the transaction request.

As described above, the provider computing system 102 may cause the user device 104 to display a transaction verification interface 600. The transaction verification interface 600 may be overlayed over the user interface 500, such that the user interface 500 and the transaction verification interface 600 are displayed on the user device 104 simultaneously. In some arrangements, the transaction verification interface 600 includes an interactive icon 602 that, when selected by a user, causes the provider computing system 102 to perform a transaction verification process, such as one or more of the methods shown in FIGS. 2-4.

FIG. 6 depicts the example user interface 500 displayed on the user device 104, after a user selection of the interactive icon 602. In some arrangements, the interactive icon 602 may be highlighted or otherwise changed to indicate that the user has selected the interactive icon 602. In other arrangements, the interactive icon 602 may not change responsive to a user selection of the interactive icon 602.

Responsive to the user selection of the interactive icon 602, the provider computing system 102 may perform a transaction verification process, such as one or more of the methods shown in FIGS. 2-4. The provider computing system 102 may cause the user device 104 to display a notification 620 via the transaction verification interface 600. The notification 620 may be overlayed on top of the user interface 500. In some arrangements, the notification 620 indicates a result of the transaction verification process. For example, the notification 620 may indicate that the input party data is incorrect or likely incorrect. In another example, the notification 620 may indicate that the input party data is correct or likely correct. In yet another example, the notification 620 may include a confidence score regarding the input party data.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include various forms of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A system comprising:
at least one processing circuit having at least one processor coupled to at least one memory device, the at least one memory device storing instructions thereon that, when executed by the at least one processor, cause the at least one processing circuit to perform operations comprising:
storing data regarding a plurality of transaction parties;
receiving, from a user device, data regarding a transaction request for a transaction between a first party and a second party, the data regarding the transaction request comprising a first set of party characteristics associated with the first party;
verifying the first set of party characteristics based on determining that the first party is one of the plurality of transaction parties;
determining that at least one characteristic of the first set of party characteristics is incorrect based on comparing the first set of party characteristics with the data regarding the plurality of transaction parties; and
causing the user device to display a notification indicating that the at least one characteristic is incorrect, wherein the notification is overlayed on a transaction portal interface.

2. The system of claim 1, wherein the operations further include:
storing one or more party characteristics corresponding to each transaction party of the plurality of transaction parties; and
verifying the first set of party characteristics is further based on determining that a second party characteristic of the first set of party characteristics matches at least one of the one or more party characteristics corresponding to the first party.

3. The system of claim 1, wherein the operations further include:
storing a number of completed transactions for each transaction party of the plurality of transaction parties; and
verifying the first set of party characteristics is further based on determining that a number of completed transactions of the first party is at or above a predetermined threshold.

4. The system of claim 1, wherein the operations further comprise:
determining a confidence score regarding the first party based on at least one of:
comparing the first set of party characteristics to a list of party characteristics, identifying a government issued identification characteristic of the first party;
comparing a number of returned transactions initiated by the first party with a returned transaction threshold; or
a type of interface of the transaction portal interface;
wherein verifying the first set of party characteristics is further based on determining that the confidence score is greater than a confidence score threshold.

5. The system of claim 4, wherein the operations further comprise:
storing a number of completed transactions for each transaction party of the plurality of transaction parties; and
verifying the first set of party characteristics is further based on determining that a number of completed transactions of the first party is at or below a predetermined threshold and that the confidence score is greater than the confidence score threshold.

6. The system of claim 4, wherein the system is further configured to cause the user device to display the confidence score, wherein the confidence score is overlayed on the transaction portal interface.

7. The system of claim 1, wherein the data regarding the transaction request further comprises an indication that the transaction is a first transaction between the first party and the second party.

8. The system of claim 1, wherein:
the transaction portal interface is provided on the user device via a third-party provider application; and
the at least one processing circuit is configured to cause the user device to display the transaction portal interface and the notification simultaneously.

9. A method comprising:
storing, by a provider computing system, data regarding a plurality of transaction parties;
receiving, by the provider computing system and from a user device, data regarding a transaction request for a transaction between a first party and a second party, the data regarding the transaction request comprising a first set of party characteristics associated with the first party;
verifying, by the provider computing system, the first set of party characteristics based on determining that the first party is one of the plurality of transaction parties;
determining, by the provider computing system, that at least one characteristic of the first set of party characteristics is incorrect based on comparing the first set of party characteristics with the data regarding the plurality of transaction parties; and
causing, by the provider computing system, the user device to display a notification indicating that the at least one characteristic is incorrect, wherein the notification is overlayed on a transaction portal interface.

10. The method of claim 9, further comprising:
storing one or more party characteristics corresponding to each transaction party of the plurality of transaction parties; and
verifying the first set of party characteristics is further based on determining that a second party characteristic of the first set of party characteristics matches at least one of the one or more party characteristics corresponding to the first party.

11. The method of claim 9, further comprising:
storing a number of completed transactions for each transaction party of the plurality of transaction parties; and
verifying the first set of party characteristics is further based on determining that a number of completed transactions of the first party is at or above a predetermined threshold.

12. The method of claim 9 further comprising:
determining, by the provider computing system, a confidence score regarding the first party based on at least one of:
comparing the first set of party characteristics to a list of party characteristics, identifying a government issued identification characteristic of the first party;
comparing a number of returned transactions initiated by the first party with a returned transaction threshold; or
a type of interface of the transaction portal interface;
wherein verifying the first set of party characteristics is further based on determining that the confidence score is greater than a confidence score threshold.

13. The method of claim 12, further comprising:
storing a number of completed transactions for each transaction party of the plurality of transaction parties; and
verifying the first set of party characteristics is further based on determining that a number of completed transactions of the first party is at or below a predetermined threshold and that the confidence score is greater than the confidence score threshold.

14. The method of claim 12, further comprising causing the user device to display the confidence score, wherein the confidence score is overlayed on the transaction portal interface.

15. A non-transitory computer-readable storage media having instructions stored thereon that, when executed by at least one processor of a computing system, cause the computing system to perform operations including:
storing data regarding a plurality of transaction parties;
receiving, from a user device, data regarding a transaction request for a transaction between a first party and a second party, the data regarding the transaction request comprising a first set of party characteristics associated with the first party;
verifying the first set of party characteristics based on determining that the first party is one of the plurality of transaction parties;
determining that at least one characteristic of the first set of party characteristics based on comparing the first set of party characteristics with the data regarding the plurality of transaction parties; and
causing the user device to display a notification indicating that the at least one characteristic is incorrect, wherein the notification is overlayed on a transaction portal interface.

16. The non-transitory computer-readable storage media of claim 15, wherein the operations further include:
storing one or more party characteristics corresponding to each transaction party of the plurality of transaction party; and
verifying the first set of party characteristics is further based on determining that a second party characteristic of the first set of party characteristics matches at least one of the one or more party characteristics corresponding to the first party.

17. The non-transitory computer-readable storage media of claim 15, wherein the operations further include:
storing a number of completed transactions for each transaction party of the plurality of transaction parties; and
verifying the first set of party characteristics is further based on determining that a number of completed transactions of the first party is at or above a predetermined threshold.

18. The non-transitory computer-readable storage media of claim 15, wherein the operations further comprise:
determining a confidence score regarding the first party based on at least one of:
comparing the first set of party characteristics to a list of party characteristics, identifying a government issued identification characteristic of the first party;
comparing a number of returned transactions initiated by the first party with a returned transaction threshold; or
a type of interface of the transaction portal interface;
wherein verifying the first set of party characteristics is further based on determining that the confidence score is greater than a confidence score threshold.

19. The non-transitory computer-readable storage media of claim 18, wherein the operations further comprise:
storing a number of completed transactions for each transaction party of the plurality of transaction parties; and
verifying the first set of party characteristics further based on determining that a number of completed transactions of the first party is at or below a predetermined threshold and that the confidence score is greater than the confidence score threshold.

20. The non-transitory computer-readable storage media of claim 18, wherein the operations further comprise causing the user device to display the confidence score, wherein the confidence score is overlayed on the transaction portal interface.
